(19) United States
(12) Patent Application Publication
(10) Pub. No.: US 2003/0235321 A1
(43) Pub. Date: Dec. 25, 2003

(54) Earphone device of head-hanging type

(75) Inventor: I-Chang Lu, KaoHsiung (TW)

Correspondence Address: BRUCE H. TROXELL, SUITE 1404, 5205 LEESBURG PIKE, FALLS CHURCH, VA, 22041, US

(73) Assignee: AIPTEK INTERNATIONAL INC.

(21) Appl. No.: 10/175,036

(22) Filed: Jun. 20, 2002

(51) Int. Cl. H04R 25/00

(52) U.S. Cl. 381/381; 381/330

(57) ABSTRACT

The invention provides an earphone device of head-hanging type, comprising: an earphone main body, a pivoting-and-fixing part, and a hanging hook. The earphone main body abutted against one external ear of human body. The abutting side of the earphone main body has an opening trough. The pivoting-and-fixing part having a plurality of fixation seats connected with the opening trough. There is a penetration hole arranged at an appropriate position of the fixation seat. A pivoting axis may pass through the penetration hole and be connected with the fixation seat. Two sides of the pivoting axis are respectively protruded out the fixation seat. The hanging hook connected with the pivoting-and-fixing part and at least has: an arm capable of being hanged at the outer edge of the external ear and a pivoting part connected to one end of the arm. Two sides of the pivoting part respectively have a pivoting seat, wherein the interior of the pivoting seat has a through hole, provided for the pivoting axis to pass through. By arranging at least one pivoting seat with one through trough to pass through the through hole, the pivoting axis placed into the through hole through the through trough.

### 1. FIELD OF THE INVENTION

The invention relates to an earphone device, particularly to a kind of earphone device of head-hanging type that hanged at the external ear of human body.

### 2. BACKGROUND OF THE INVENTION

Since technology is changed with each passing day, so communication between people is become more frequent and their interaction is also become more intimate. On the emphasis of high living standard of today, recreation activity no doubt becomes indispensable for everybody. The development of technology has made electronic products penetrate into each family and various walks of life. Especially, the electronic facilities of image and video have further become the necessity of recreation activities in modem living. Following the prevalence of electronic products, it is further needed more accessory products to be interconnected as the functions of input, output and usage. Therefore, the earphone device is dignified as one of the best devices of output among the electronic products of image and video of today.

The casing of the earphone according to the prior arts is covered with an amplifier, which is placed between the contour of the external ear and the projection of human body, such that the ear cavity may receive the sound signal of the amplifier but, after the long term of usage of the earphone according to the prior arts, not only will the ear be uncomfortable, but also will the tinnitus and the weakness of hearing be incurred. Therefore, the relative businessmen develop an earphone of head-hanging type, which can be hanged at the external ear of human body and be kept an appropriate distance with the interior of ear cavity. Therefore, the sound signal of the amplifier is received by the contour of the ear first and is transferred into the interior of the ear cavity then, so it would not be incurred the uncomfortable tinnitus and the weakness of hearing because of the long term of reception of the sound signal of the amplifier. But, since the assembly of the earphone of head-hanging type according to the prior arts is complicated and uneasy, so it is frequently incurred damages and breaks during assembly process, such that the labor time and the cost of manufacture are increased. This is a problem needed to solve urgently by the relative business to thereby lower down the disbursement of cost and enhance the competition ability of business. The solution and breakthrough of such problem are really demanded without any further delay.

### SUMMARY OF THE INVENTION

The main object of the invention is to provide an earphone device of head-hanging type, be connected through a mechanism design of a pivoting-and-fixing part of an earphone main body for providing a hanging hook facilitated to be separated from and assembled with the earphone main body, so that it can achieve the further enhancement of the functions exiting in original earphone of head-hanging type, the reduction of complexity of the assembly, and the function of lowering down the labor time and the cost of production.

To achieve above object, the earphone device of head-hanging type according to the invention is comprised of an earphone main body, a pivoting-and-fixing part, and a hanging hook.

The earphone main body abutted against one external ear of human body, and the abutting side of the earphone main body has at least one opening trough.

The pivoting-and-fixing part has a plurality of fixation seats and a pivoting axis. The fixation seat is connected with the opening trough. There is a penetration hole arranged at an appropriated position of the fixation seat. The pivoting axis passes through the penetration hole and is connected with the fixation seat. Two sides of the pivoting axis are respectively projected out the fixation seat.

The hanging hook connected with the pivoting-and-fixing part and it is comprised of an arm and a pivoting part. The arm provided for being hanged at the outer edge of the external ear. The pivoting part is connected to one end of the arm. Two sides of the pivoting part respectively have a pivoting seat.

Wherein, the interior of the pivoting seat has a through hole, provided for the pivoting axis to pass through. By arranging at least one pivoting seat with one through trough to pass through the through hole, the pivoting axis placed into the through hole through the through trough.

For your esteemed members of reviewing committee to further understand and recognize the merits of the present invention, a detailed description matching with corresponding drawings are presented as follows.

### BRIEF DESCRIPTION OF THE DRAWINGS

FIG. 1A is an assembly illustration for the three-dimensional structure of the preferable embodiment of the earphone device of head-hanging type according to the present invention.

FIG. 1B is an explosive illustration for the three-dimensional structure of the preferable embodiment of the earphone device of head-hanging type according to the present invention.

FIG. 2 is an illustration for the three-dimensional structure of the preferable embodiment of the connection between the earphone main body and the pivoting-and-fixing part according to the present invention.

FIG. 3A is an illustration for the three-dimensional structure of the first preferable embodiment of the hanging hook according to the present invention.

FIG. 3B is an illustration for the three-dimensional structure of the second preferable embodiment of the hanging hook according to the present invention.

### DETAILED DESCRIPTION OF THE INVENTION

The main technical spirit of the invention is to arrange at least one pivoting seat with a through trough to guide through the through hole, such that the pivoting axis through the through trough and placed into the through hole. Further, it can be through lifting off t he hanging hook to make the pivoting axis be able to be separated from the through hole through the through trough, such that the shortcomings of the impossibility for interchange and the difficulty for assembly can be overcome.

In following, a detailed description of several preferable embodiments of the earphone device of head-hanging type according to the present invention is presented, such as: detailed means, action manner, achieving function, and other characteristics of the invention, etc.

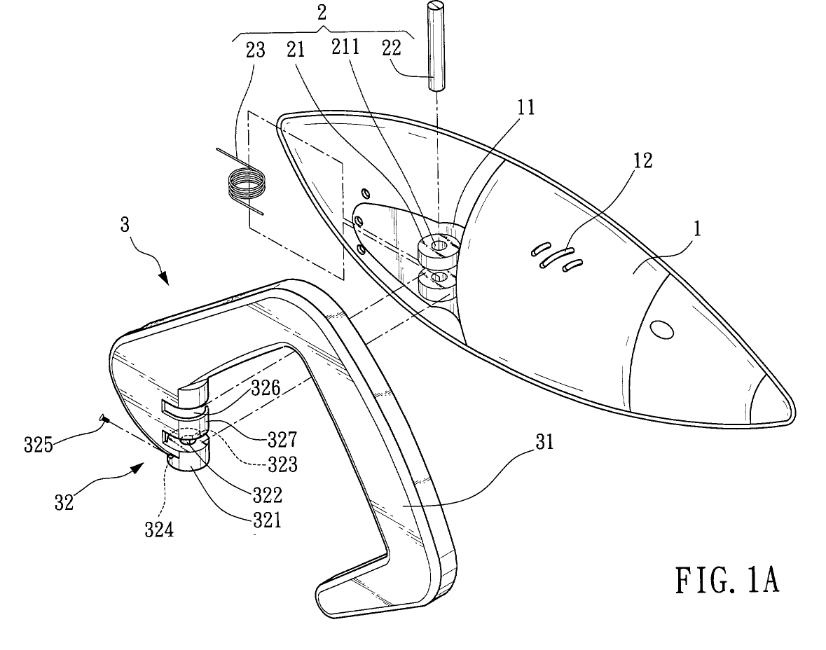

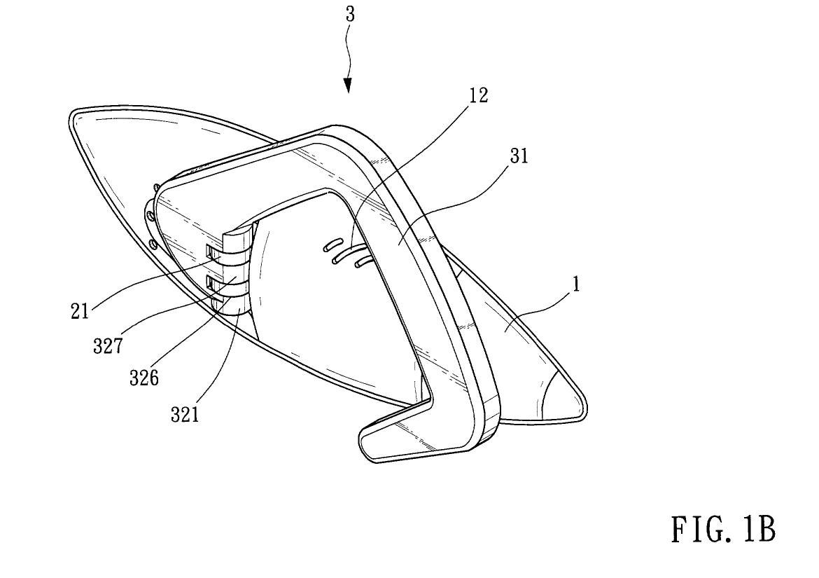

Please refer to FIG. 1A and FIG. 1B, which are the illustrations of the three-dimensional structures of the preferable embodiments of the earphone device of head-hanging type according to the present invention. The earphone device of head-hanging type is mainly comprised of an earphone main body 1, a pivoting-and-fixing part 2, and a hanging hook 3. The earphone main body 1 is structured as a shape of water drop and is able to be abutted against one external ear of human body (not shown in the figure) and, through arranging an amplifier 12 corresponding to the external ear, a sound signal is provided. However, above structure is belonged to the prior arts and is not the technical characteristic of the present invention, so it will not be described in any more detail. The abutting side of the earphone main body 1 has at least one opening trough 11. In the preferable embodiments of the invention, the opening trough 11 is formed as an arc shape and, of course, it may also be designed as a rectangular shape or other forms. Such kind of variation implemented by those who are skilled in such arts according to above disclosure, but it still possesses the merits of the invention and it is also within the spirit and scope of the invention, so a detailed description is not presented herein any further.

The pivoting-and-fixing part 2 is at least arranged with a plurality of fixation seats 21, a pivoting axis 22, and at least one elastic element 23. The fixation seat 21 is connected integrally with the opening trough 11 as one body. The top part of the fixation seat 21 is designed as a circular shape in facilitating the rotation of the hanging hook 3. A penetration hole 211, arranged at an appropriate position of the center, is designed as a circular shape. In the preferable embodiments of the invention, the number of the fixation seat 21 is two; of course, it may also be three or more. Such kind of variation of number implemented by those who are skilled in such kinds of arts according to above disclosure, but it still possesses the merits of the invention and it is also within the spirit and scope of the invention, so a detailed description is not presented herein any further. The pivoting axis 22, matched with the penetration hole 211, is a cylinder structure. The number of the elastic element 23 is at least one and it is arranged between two adjacent fixation seats 21. If, when the number of the fixation seat 21 is three, then the number of the elastic element 23 is two, and such kind of variation of number is not repetitiously described herein any further.

The hanging hook 3 connected with the pivoting-and-fixing part 2. The hanging hook 3 at least has an arm 31 and a pivoting part 32. The arm 31 may be provided for being hanged at the outer edge of the external ear. The abutting side of external ear of the arm 31 is designed according to the ergonomics, such that it may be hanged at the external ear comfortably. The pivoting part 32 is connected to one end of the arm. Two sides of the pivoting part 32 respectively have a pivoting seat 321. In the preferable embodiment of the invention, the pivoting part 32 has a plurality of trough ditches 326 corresponding to the fixation seats 21. An elastic piece 327 is further arranged between two adjacent trough ditch 326. Of course, when the number of the fixation seat 21 is two, the number of the trough ditch 326 is also two, while the number of the elastic piece is one. When the number of the fixation seat 21 is three, the number of the trough ditch 326 is three, while the number of the elastic piece 327 is two. Such kind of variation of number is not repetitiously described herein any further.

Wherein, the interior of the pivoting seat 321 has a through hole 322, which may be provided for the pivoting axis 22 to pass through. By arranging at least one pivoting seat 321 with a through trough 323 to guide through the through hole 322, the pivoting axis 22 is made to be through the through trough 323 and be placed into the through hole 322. In the assembly procedure for the preferable embodiments according to the present invention, the pivoting axis 22 is first placed into the through hole 322 of the pivoting seat 321 that is not arranged with the through trough 322 and, the pivoting seat 321, one end of which is arranged with the through trough 323, is then placed into the through hole 322 through the through trough 323, such that the connection motion is completed. Of course, in the preferable embodiment of the invention, the pivoting seat 321 has a locking-and-fixing hole 324 corresponding to the through trough 323, and the pivoting seat 321 and the pivoting axis 22 are locked and secured together by screwing the locking-and-fixing hole 324 with a bolt 325.

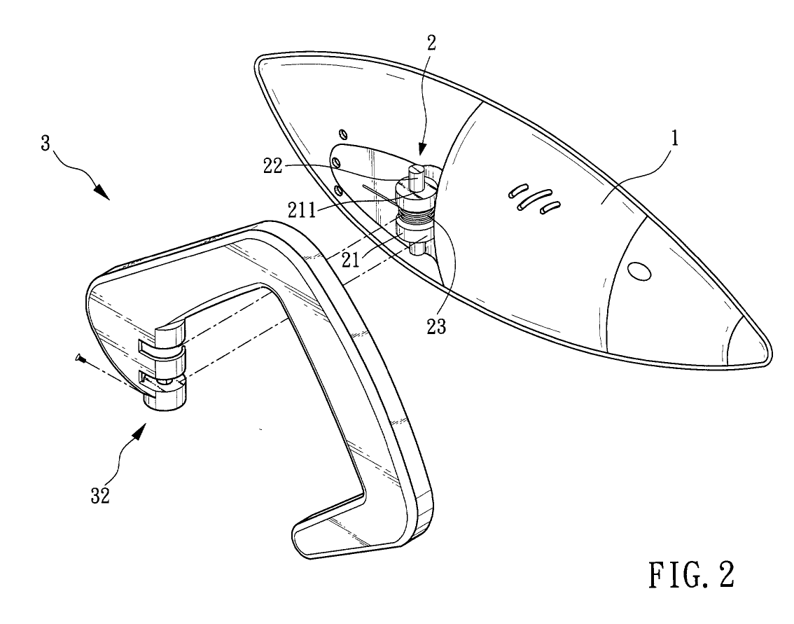

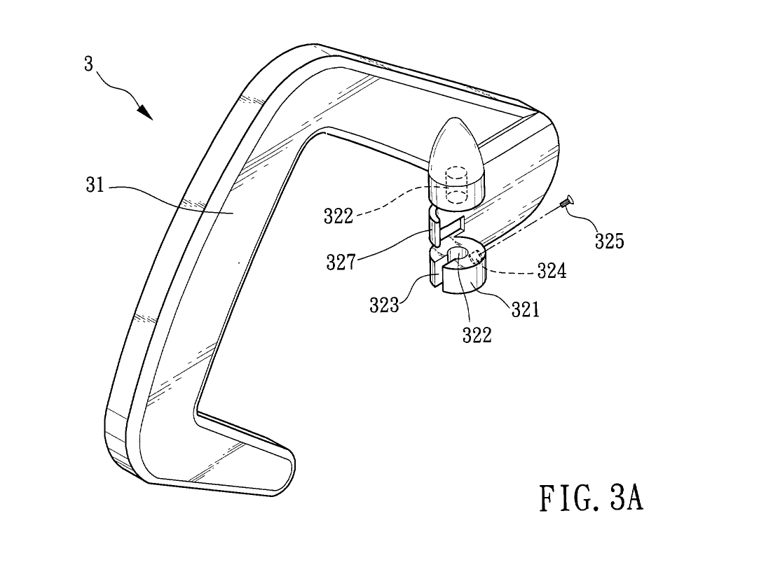

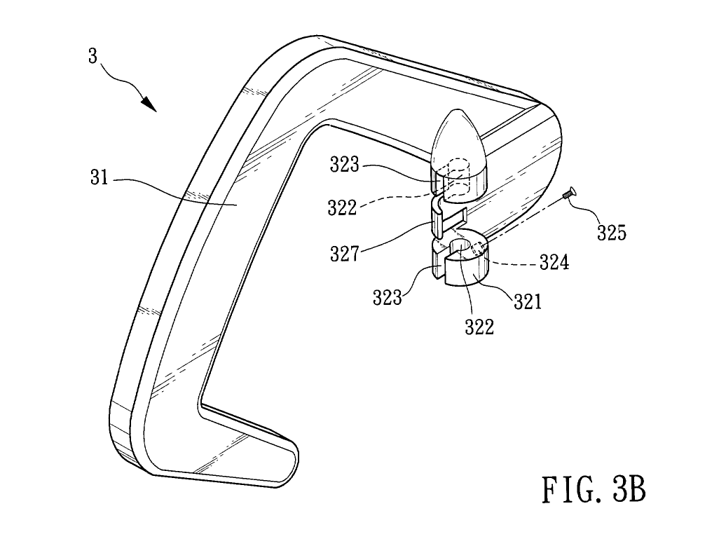

To further understand the preferable embodiment of the invention, please refer to FIG. 2, which is the illustration of a three-dimensional structure of the preferable embodiment of the connection and assembly between the earphone main body and the pivoting-and-fixing part of the present invention. The earphone main body 1 and the pivoting-and-fixing part 2 of the invention are first assembled, connected, and then jointed to the hanging hook 3. The pivoting axis 22 first passes through the penetration hole 211 of the fixation seat 21, penetrates into the elastic element 23, and then passes through another penetration hole 211 again, such that two sides of the pivoting axis 22 respectively protrude out the fixation seat 21 for facilitating its connection with the hanging hook 3. FIG. 3A and FIG. 3B are the illustrations for the three-dimensional structure of the preferable embodiment of the hanging hook according to the present invention. Since most parts of the elements are same as or similar to those of the described embodiments, so the same element will be directly referred with same name. In FIG. 3A, a single pivoting seat 321 is arranged with a through trough 323 and, of course, the through trough 323 may also be arranged at another pivoting seat 321 while, in FIG. 3B, the two pivoting seats 321 are respectively arranged with a through trough 323. Such kind of variation of number may all reach the assembly motion of previously described embodiments. In sum, the earphone device of head-hanging type according to the present invention may indeed reach the functions exiting in original earphone of head-hanging type, further reduces the complexity of assembly, and lowers down the labor time and cost of production. The shortcomings of the prior arts are really overcome, the requests of the industrial production are fulfilled, and their abilities of manufacturing competition are also enhanced.

What is claimed is:

1. An earphone device of head-hanging type, comprising:
an earphone main body, abutted against one external ear of human body, and the abutting side of the earphone main body has at least one opening trough;
a pivoting-and-fixing part, comprising:
a plurality of fixation seats, connected with the opening trough and there is a penetration hole arranged at an appropriated position of the fixation seat;
a pivoting axis, pass through the penetration hole and be connected with the fixation seat, and two sides of the pivoting axis are respectively projected out the fixation seat; and
a hanging hook, connected with the pivoting-and-fixing part, comprising:
an arm, provided for being hanged at the outer edge of the external ear;
a pivoting part, connected to one end of the arm and two sides of the pivoting part respectively having a pivoting seat;
wherein the interior of the pivoting seat having a through hole, provided for the pivoting axis to pass through, by arranging at least one pivoting seat with one through trough to pass through the through hole, the pivoting axis placed into the through hole through the through trough.

2. The earphone device of head-hanging type according to claim 1, wherein the pivoting axis having a locking-and-fixing hole corresponding to the through trough, wherein the pivoting seat and the pivoting axis are connected together by screwing the locking-and-fixing hole with a bolt.

3. The earphone device of head-hanging type according to claim 1, wherein the pivoting-and-fixing part having an elastic element, placed between two adjacent fixation seats.

4. The earphone device of head-hanging type according to claim 1, wherein the pivoting part having a plurality of trough ditches corresponding to the fixation seats.

5. The earphone device of head-hanging type according to claim 4, wherein the pivoting part having at least one elastic piece, placed between two adjacent trough ditches.
